(19) United States
(12) Patent Application Publication
(10) Pub. No.: US 2010/0153249 A1
(43) Pub. Date: Jun. 17, 2010

(54) Making Payment Using Communication Client

(75) Inventors: Leiming Yuan, Hangzhou (CN); Wenjin Liang, Hangzhou (CN); Lei Ma, Hangzhou (CN)

Correspondence Address: LEE & HAYES, PLLC, 601 W. RIVERSIDE AVENUE, SUITE 1400, SPOKANE, WA, 99201, US

(73) Assignee: Alibaba Group Holding Limited, Grand Cayman (KY)

(21) Appl. No.: 12/600,525

(22) PCT Filed: Jun. 24, 2009
(86) PCT No.: PCT/US2009/048490

§ 371 Date: Nov. 17, 2009

(30) Foreign Application Priority Data
Jun. 25, 2008 (CN) 200810128423.6

(51) Int. Cl. G06Q 20/00; G06Q 10/00; G06Q 50/00; G06Q 40/00; H04M 1/66; H04L 12/58; H04W 4/12

(52) U.S. Cl. 705/34; 705/30; 705/40; 705/44; 455/411; 455/412.1; 455/466

(57) ABSTRACT

Disclosed are a method and a system for making a payment to a third party using a communication client such as a mobile phone. The payment is made through an intermediary platform adapted for establishing communication between the communication client and the third-party subsystem. The intermediary platform receives a call-in request from the communication client, determines whether the communication client has a mobile telephone number, and further determines whether the mobile telephone number has a payment account bound therewith. If affirmative, the intermediary platform accepts a payment request from the communication client, and makes a deduction from the payment account in order to complete the payment. The intermediary platform may also be used to make a payment to the third-party through a network client such as a PC.

### RELATED APPLICATIONS

This application is a national stage application of international patent application PCT/US09/48490 filed Jun. 24, 2009, entitled “MAKING PAYMENT USING COMMUNICATION CLIENT”, which claims priority from Chinese patent application, Application No. 200810128423.6, filed Jun. 25, 2008, entitled “PAYMENT METHOD AND SYSTEM USING COMMUNICATION CLIENT”, which applications are hereby incorporated by reference in their entirety.

### TECHNICAL FIELD

The present disclosure relates to communication field, and particularly relates to payment methods and systems using a communication client.

### BACKGROUND

Online shopping over a network has become the mainstream today. However, not every person can conveniently make a purchase using the network. Moreover, only a few of the great number of existing telephone customer groups use a wireless communication system to conduct business activities other than just communication.

Today, one of the most commonly seen payment methods using a communication client is teleshopping, which utilizes a communication client such as a landline telephone, a mobile telephone, or a personal handphone system. A workflow of a teleshopping method is as follows. First, a merchant advertises product information and a related payment method through media such as newspaper, magazine, and television. A user may establish communication with the merchant's call center using a communication client (e.g., a mobile telephone or a landline telephone) of the user end, and inform the merchant of a product to be purchased and the corresponding payment method. Finally, upon confirming that the user has made a payment, the merchant delivers the product. Alternatively, the merchant may deliver the product and receive the payment through face-to-face handover. Devices that may be deployed in a call center of a merchant include a switching device having a capability of concurrency processing, and a certain number of communication clients for handling calls from multiple users. However, taking operating cost into consideration (i.e., the costs for buying and maintaining switching devices and communication clients, and the cost for hiring personnel to answer calls, etc), the number of user calls that can be answered may be very limited. This may incur excessively long waiting times for users with a conventional merchant call center, causing some users to give up transactions, and thus reducing the rate of successful transaction between the users and the merchant. From the perspective of the overall operating model, a merchant is considered as a virtual merchant. Neither authenticity, nor quality of an item purchased from the merchant can be determined by a user. From the merchant's perspective, the biggest challenge is how to reduce a sense of mistrust of a user to improve the volume of sales.

Intermediary platforms, such as YeePay, and PayEase, have provided a payment method of telephone banking using a communication client. This payment method improves security of a payment of a user, and hence improves the rate of successful transaction to a certain degree. A payment process of the method is as follows.

First, a user specifies a bank card of a card issuer for telephone banking in advance.

Upon completing a product order with a merchant which cooperates with an intermediary platform such as YeePay, and PayEase, the user selects a telephone payment method of the intermediary platform, and leaves a telephone number.

After completing the order, the user calls the telephone banking service hotline of the card issuer, and selects the telephone payment of the intermediary platform. If the calling number matches the telephone number left when placing the order, the user only needs to confirm the payment being made for the order. If not, the user first inputs the telephone number that has been left when placing the order. Upon hearing a voice report of the order information, the user confirms and completes the payment by pressing a key.

Finally, after the user confirms the payment, the card issuer deducts corresponding amount from the bank card of the user, and returns a status of a successful deduction to the intermediary platform which then notifies the merchant that the user has successfully made the payment.

Some technical deficiencies exist in this payment method using a communication client. The method receives support from only a limited number of banks, requires a merchant to have a call center system and often to have the system modified and adapted, and has relatively high implementation costs and transaction costs from a merchant's perspective.

Existing technologies further include a “pay by card” payment method (e.g., MOTOPAY, a product of Chinabank Payment), and a payment method using a smart telephone terminal for making a payment. An exemplary workflow of the “pay by card” payment method is as follows. A user verifies an order with a merchant by telephone and provides credit card information such as a credit card number, CVV2 code (i.e., the last three digits on a signature strip), and an expiry date to the merchant. The merchant then verifies the information with the card issuer. Upon receiving a feedback indicating successful verification from the card issuer, the merchant establishes the order, and completes a deduction. This type of a workflow also has a technical deficiency. A user may pull back from an order or refuse to make a payment, thus incurring a high transaction risk to the merchant.

The above-mentioned payment method using a smart telephone terminal requires using a smart telephone terminal provided by an intermediary platform such as UnionPay, and is suitable for making a purchase at a fixed location. This payment method, however, is deficient to support making purchase and payment by a moving user, requires additional expenses for a merchant to purchase terminal devices, and has a narrow scope of suitable merchants due to requirements set by intermediary platforms such as UnionPay for merchants using smart telephone terminals.

In summary, the existing payment methods using a communication client have following deficiencies.

First, the above-discussed conventional methods using a communication client to conduct a payment all fall short of providing a convenient payment method that has high security and low cost. This greatly limits the possibility of exploring businesses other than communications for a huge number of communication customers. For example, although the payment methods using a communication terminal of telephone banking provided by intermediary platforms such as YeePay and PayEase do have high security for making a payment, only a few card issuers currently support these types of payment. These payment methods have a narrow scope of use due to inconveniences incurred to buyers and merchants in operation. The “pay by card” payment method employs a pattern in which the user confirms the order first, the merchant then delivers the product, and finally the merchant receives the payment through a card issuer. In today's societies which may have an imperfect personal credit system, this pattern gives rise to low transaction security for merchants. The payment method using a smart telephone terminal requires each merchant to spend on extra hardware, and thus increases transaction costs.

Second, using a communication client for making a payment within a shopping process only has a limited usage.

Third, the existing methods of shopping using a telephone and shopping using the Internet belong to two separate systems and do not share resources, causing a waste of resources.

### SUMMARY OF THE DISCLOSURE

Disclosed are a method and a system for making a payment using a communication client such as a mobile phone. The payment is made through an intermediary platform adapted for establishing communication between the communication client and a third-party subsystem. The intermediary platform receives a call-in request from the communication client, determines whether the communication client has a mobile telephone number, and further determines whether the mobile telephone number has a payment account bound therewith. If affirmative, the intermediary platform accepts a payment request from the communication client, and makes a deduction from the payment account in order to complete the payment.

The intermediary platform has installed thereupon an account subsystem to establish communication with a payment card issuer and to accept an account recharging service. The payment account bound with the mobile phone number may be opened with the payment card issuer.

In one embodiment, the intermediary platform is adapted for communicating with the communication client wirelessly. The intermediary platform may also be adapted for communicating with the communication client through text messaging or TTS-based voice prompting. The intermediary platform can be adapted for periodically conducting account checking and account settlement with the third-party subsystem and a subsystem of the payment card issuer.

The third-party subsystem may belong to a third-party payee, and the payment request includes at least information of the third-party subsystem.

In one embodiment, the method further establishes a connection between the intermediary platform and the Internet, and performs an operation requested by a user who accesses the intermediary platform through the Internet. The operation may be one or more of actions including setting up account information of the user, setting up user identity information, inquiring payment information and the payment account information, and binding the mobile telephone number with the payment account.

In one embodiment, the method verifies the mobile telephone number by sending a random verification code in form of a text message to the mobile telephone number; receiving a user returned verification code; and comparing the random verification code with the user returned verification code.

Before making a deduction from the payment account, a maximum limit of the deduction may be set. The deduction is made by the intermediary platform only if the deduction satisfies the maximum limit.

The intermediary platform may be adapted for communicating with the communication client through a voice prompt or text messaging.

If the mobile telephone number does not have a payment account bound therewith, the method may further determine whether a payment account associated with the user of the communication client exists in the intermediary platform; if affirmative, the system establish his a binding relationship between the payment account and the mobile telephone number; and if negative, the system creates a payment account associated with the user and binds the payment account with the mobile telephone number.

In one embodiment, the method allows the communication client to communicate with a telecom carrier subsystem through the intermediary platform. The telecom carrier subsystem determines whether to recharge a user account based on a processing result of payment account deduction sent from the intermediary platform, and notifies the user of a recharging result. In another embodiment, the third-party subsystem is associated with a public-service, and the method further allows the communication client to send public service payment information including an order number that needs to be paid to the third-party subsystem through the intermediary platform. The intermediary platform receives from the third-party subsystem payment information including verification information of the third-party subsystem and fee information, and returns to the third-party subsystem an account deduction processing result to allow the third-party subsystem to modify the payment status of the public service.

Another aspect of the present disclosure is a system for making a payment. The system includes an intermediary platform adapted for separately processing a request from a network client and a request from a communication client. The intermediary platform includes a database, a server center, and a wireless communication subsystem. The intermediary platform allows a user to make a payment to a third-party subsystem using either one or both of the network client and the communication client. The wireless communication subsystem is adapted for establishing communication with the communication client through a wireless communication network. The server center includes a network communication interface used for separately establishing communication with the network client and the third-party subsystem.

In one embodiment, the database and the server center comprise an account subsystem including an account processing unit and an account storage unit. The account storage unit stores a binding relationship between a mobile telephone number and a payment account, and the account processing unit is adapted for creating the payment account and for creating and deleting the binding relationship between the payment account and the mobile telephone number.

In one embodiment, the database further includes a payment information storage unit used for storing payment information, and for storing encoding rules that have been agreed upon between the third-party subsystem and the intermediary platform. The database may further include a third-party storage region used for storing a verification code of the third-party subsystem.

The disclosed method and system provide a convenient, highly secure, and low-cost way to make a payment using a communication client, as well as using a network client. This broadens the business applications of online payment and allows a great number of communication customers to take advantage of a convenient, highly secure, and low-cost payment method using communication devices such as mobile phones and the communication networks.

### DESCRIPTION OF DRAWINGS

The detailed description is described with reference to the accompanying figures. In the figures, the use of the same reference numbers in different figures indicates similar or identical items.

FIG. 1 shows a structural diagram of an exemplary system for making a payment using a communication client in accordance with the present disclosure.

FIG. 2 shows a structural diagram of an exemplary wireless communication subsystem in accordance with the present disclosure.

FIG. 3 shows a flow chart of making a payment using a communication client in accordance with the present disclosure.

### DETAILED DESCRIPTION

The present disclosure is described below in further detail using accompanying figures.

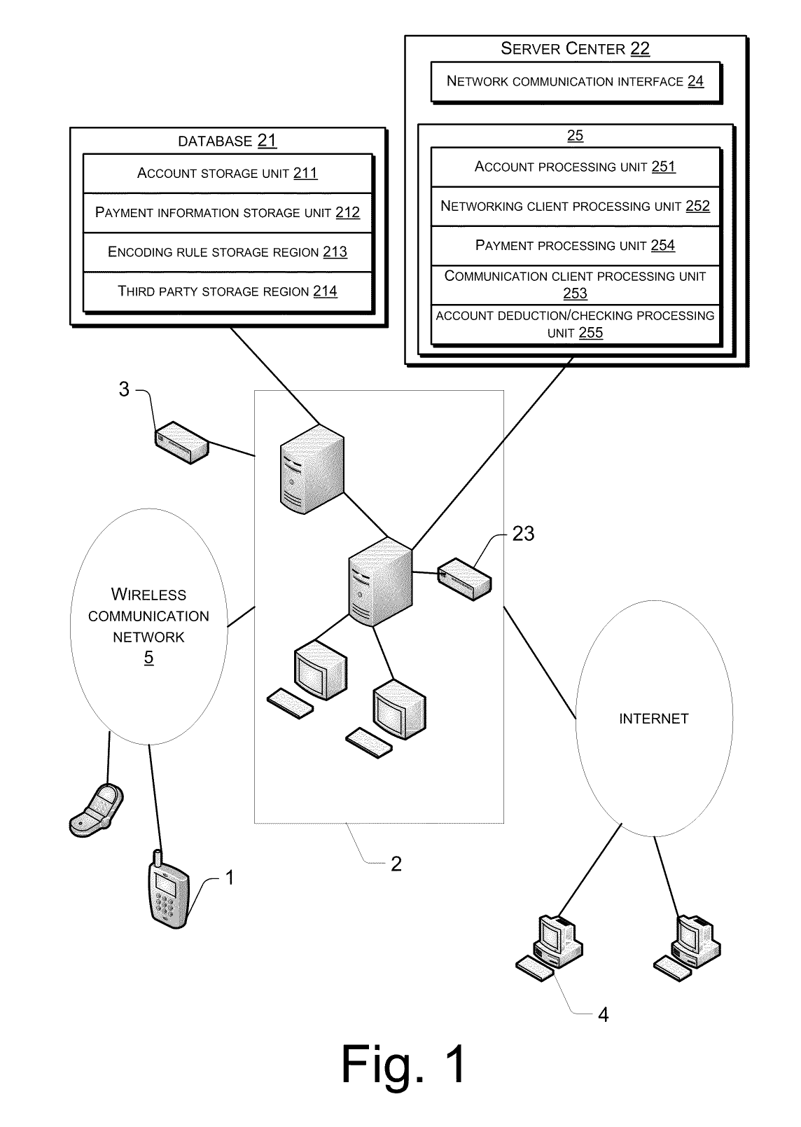

FIG. 1 shows a structural diagram of an exemplary system for making a payment using a communication client in accordance with the present disclosure. The system includes a communication client 1 used by a user, an intermediary platform 2, and a third-party subsystem 3. The communication client 1 of the user may be a mobile telephone, a PDA having communication capability, a landline telephone, etc. The third-party subsystem 3 may be a merchant, a bank subsystem which has signed an agreement with a merchant, a public service platform, a telecom carrier, etc. The third-party subsystem 3 signs an agreement with the intermediary platform 2 in advance, and sets up a verification code corresponding to the third party and processing procedures agreed upon by both parties. The third-party subsystem 3 connects with the intermediary platform 2 through a network or a designated line. The network may be a wireless communication network or the Internet. The intermediary platform 2 connects with the communication client 1 of the user through a wireless communication network 5. The intermediary platform 2 may further connect with a networking client 4 used by the same or a different user through the Internet.

The user may perform operations such as making a payment, setting up an account, setting or modifying identity verification information through the communication client 1. Alternatively, the user may complete such operations as making a payment, setting up an account, setting or modifying identity verification information through the networking client 4. Through the intermediary platform 2, the disclosed system integrates an existing network payment platform and a telephone payment platform to share resources and to better facilitate user operations.

The intermediary platform 2 includes a database 21, a server center 22, and a wireless communication subsystem 23. In one embodiment, components of the database 21 and the server center 22 made together serve as an account subsystem. For example, an account subsystem may include an account processing unit 251 of the server center 22 and an account storage unit 211 of the database 21. The account storage unit 211 stores at least a binding relationship between a mobile telephone number and an account of the user. In practical application, multiple binding relationships involving multiple uses are stored. The account processing unit 251 is used for creating the account, creating or deleting the binding relationship between the account and the mobile telephone number. The account subsystem may be a separately configured server, or may be integrated into the existing database 21 and the server center 22. The illustrated system generally has the account processing unit 251 integrated into a processing unit 25 of the server center 22, and the account storage unit 211 set up in the database 21, to reduce hardware involvement.

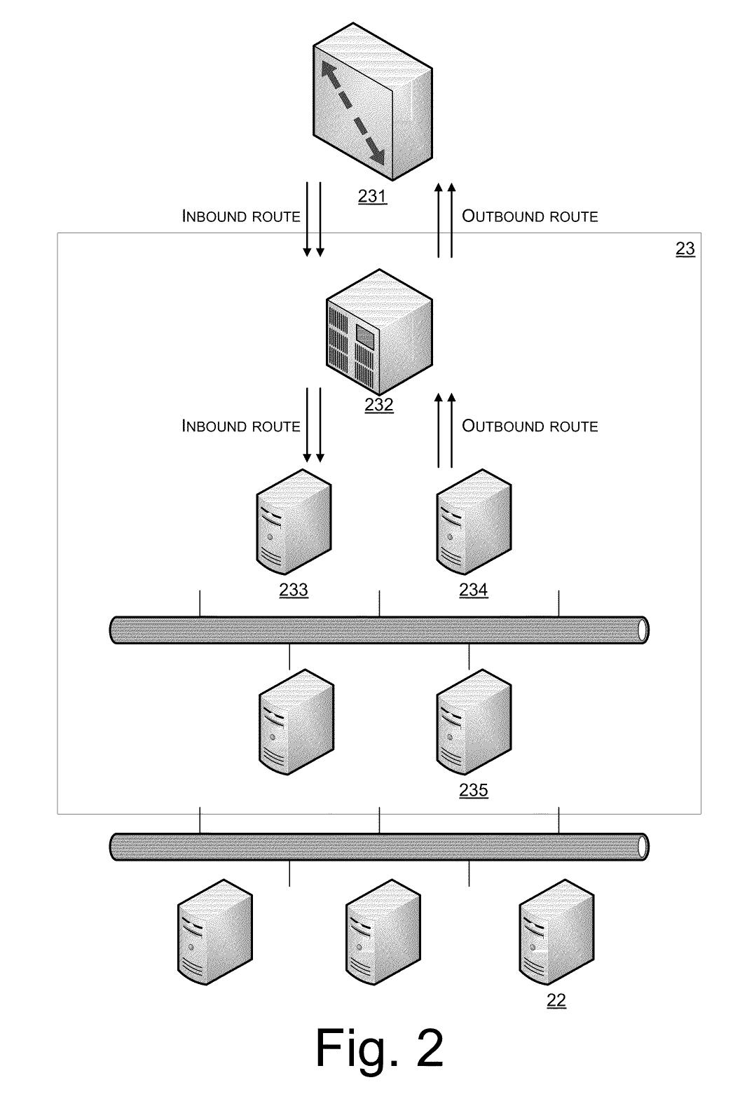

FIG. 2 shows a structural diagram of an exemplary wireless communication subsystem 23. The subsystem is primarily used for establishing communication between the intermediary platform 2 and the communication client 1 of the user through a wireless communication network. The wireless communication subsystem 23 includes a user switching device (e.g., a user PBX—private branch exchange) 232 connecting with a carrier switching device 231, an inbound server 233, an outbound server 234, and a voice gateway 235. The voice gateway 235 may connect with the server center 22, and is primarily used during a verification procedure for calling back the user using TTS (Text-To-Speech) technology. A text containing payment information is converted into voice through the voice gateway 235 to form a voice message which includes instructions on responding methods for the user. Through this procedure, the user is allowed to verify the payment information once more to avoid a loss of the user's property in event of a mismatch between a calling mobile telephone number of the user and a true mobile telephone number associated with the user. This set up not only improves the convenience of a transaction, but also provides the security of the transaction.

Referring back to FIG. 1, the database 21 includes a payment information storage unit 212, an encoding rule storage region 213, and a third-party storage region 214. The payment information storage unit 212 is used for storing payment information and the processing result of each payment. The encoding rule storage region 213 is used for storing encoding rules that are agreed upon between the third-party subsystem 3 and the intermediary platform 2. Such encoding rules may include text message contents and/or voice prompts and rules for generating user or transaction related text message contents and the voice prompts. The third-party storage region 214 is used for storing the verification code of the third-party subsystem 3 which has signed an agreement with the intermediary platform 2, and the third party's processing procedures.

The server center 22 includes a network communication interface 24 and a processing unit 25. The network communication interface 24 is used for separately establishing communication connection with the third-party subsystem 3 and the networking client 4. The processing unit 25 includes a network client processing unit 252, a communication client processing unit 253, a payment processing unit 254, and an account deduction/checking processing unit 255.

The networking client processing unit 252 is used for receiving requests for operations from a user who accesses the intermediary platform 2 through the Internet, and for processing the relevant data in a database based on the request. Examples of the requested operations include setting up the account information of the user, setting up the user identity information, inquiring payment information and the account information, and binding the mobile telephone number with the account information.

The communication client processing unit 253 is used for receiving a call-in request from the communication client 1 of the user, completing identity verification of the user based on predefined procedures, and verifying the information of a payment account that has a binding relationship with a mobile telephone number set up by the user.

The payment processing unit 254 is used for receiving a payment processing request from the third-party subsystem 3, and returning a payment processing result to the third-party subsystem 3.

The account deduction/checking processing unit 255 is used for completing deduction processing and/or account checking of a relevant account.

As illustrated, the intermediary platform 2 in the present disclosure not only can connect with a network client 4 on the Internet, but can also connect with a wireless communication client 1 through a wireless communication network (e.g., the wireless communication network 5). Furthermore, the present disclosure integrates a payment method for shopping through a wireless communication network and a payment method for shopping through the Internet using the intermediary platform 2. From a user's perspective, the two combined payment methods may have a unified payment account for the same user to access or process the payment account in various ways, and thus makes the shopping more convenient. As to a third party such as a merchant, connection to the intermediary platform 2 may be made through the Internet, a wireless communication network, or a designated line to provide good expansibility and flexibility. Furthermore, large groups of customers (e.g., network users and telephone users) can be served at the same time. A card issuer such as a bank is only required to sign an agreement with the intermediary platform 2 and maintain a simple interface. This results in high security and low processing cost. From another perspective, various resources are better shared using the intermediary platform 2 described herein.

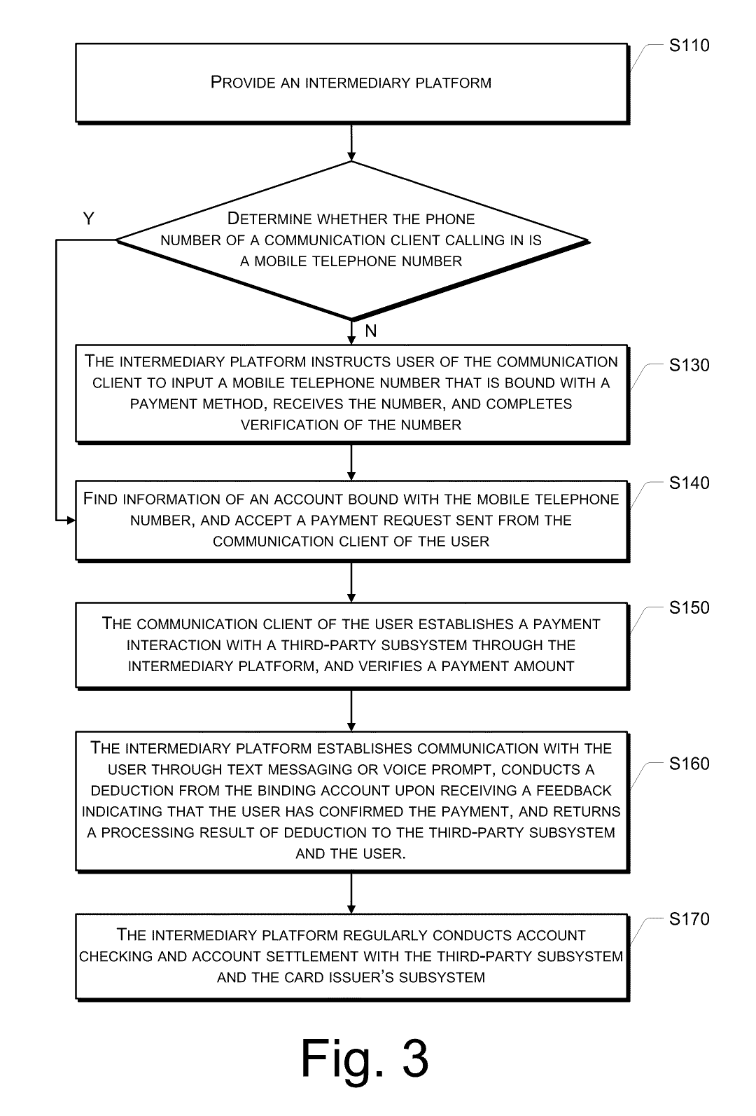

FIG. 3 shows a flow chart of making a payment using a communication client in accordance with the present disclosure. In this description, the order in which a process is described is not intended to be construed as a limitation, and any number of the described process blocks may be combined in any order to implement the method, or an alternate method. The process of FIG. 3 is described as follows.

At block S110, an intermediary platform (e.g., the intermediary platform 2) is provided. The intermediary platform is used for establishing communication between a communication client and a third-party subsystem, and has an account subsystem installed thereupon to establish communication with multiple card issuers and to accept account recharging services.

At block S120, upon receiving a call-in request from a communication client of a user, the intermediary platform determines whether the communication client's number is a mobile telephone number. If negative, the process continues to S130. If affirmative, the process proceeds to S140.

At block S130, as it has determined that the communication client's number is not a mobile telephone number, the intermediary platform instructs the user to input a mobile telephone number that is bound with a payment method, and subsequently receives the mobile telephone number entered by the user. The intermediary platform May instructed the user using automated text messaging or TTS-based voice prompting. The process proceeds to S140 upon successfully verifying the mobile number entered by the user.

Specifically, upon receiving a call-in request from the communication client of the user, the intermediary platform parses out a telephone number of the calling party (i.e., the user), and determines whether the number is a mobile telephone number. If it is not a mobile telephone number, the intermediary platform may instruct the user, through a voice prompt for example, to either input a mobile telephone number to be verified, or to hang up and make a call again using a mobile telephone which has been previously registered.

Upon receiving the mobile telephone number entered by the user, the intermediary platform verifies the mobile telephone number. The number verification may be implemented using any available method. An exemplary method that is commonly available is as follows. The intermediary platform sends a random verification code to a communication client associated with the mobile telephone number, and waits for the user to enter the received verification code to verify. The random verification code may be in form of a text message. Only if the present user is in possession or in control of the communication client associated with the registered mobile phone number would the user know and enter the correct verification code. After receiving a user input verification code through the communication client of the calling party (i.e., the user), the intermediary platform compares the received verification code with the random verification code. If the received verification code is the same as the random verification code, number verification of the number is deemed successful.

At block S140, the account subsystem determines whether the information of a payment account bound with the mobile telephone number exists. If such account information exists, the account subsystem accepts a payment request from the communication client of the user. The payment request may include at least the information of a third-party subsystem of a third-party payee.

The account subsystem may determine in advance the information of a payment account that is bound with the mobile telephone number. Such a payment account may be one whose account name is the mobile telephone number, or another account such as an existing account of the same user found in the intermediary platform (e.g., an existing account with Alipay.com). If such an account exists, the user may be instructed by way of voice prompt to input a payment request, e.g., “press 1 to recharge a mobile telephone; press 2 to pay a public service fee, press 3 to make a purchase, etc”. The account system determines a payment item requested by the user, as well as a related third party, through the keys pressed by the user.

If the account subsystem does not have the information of a payment account bound with the mobile telephone number, the account subsystem determines whether another account related to the user exists in the intermediary platform. If such an account exists in the intermediary platform, the account subsystem creates a binding relationship between the account and the mobile telephone number after the user passes identity verification. If not, the account subsystem may hang up, or instructs the user to enter identity information. Upon subsequently receiving and storing identity verification information from the user, and the account subsystem creates a new account and binds it with the mobile telephone number.

At block S150, the communication client of the user establishes an interactive payment procedure with the third-party subsystem through the intermediary platform, and confirms the amount of the payment being made.

Upon visiting the third-party subsystem through the intermediary platform, the user's communication client may directly establish the interactive payment procedure with the third-party subsystem, and has the third-party subsystem send required payment information (e.g., the present payment's serial number, the payment amount, a verification code of the third party, etc) to the intermediary platform. Alternatively, the user's communication client may indirectly establish an interactive payment procedure with the third-party subsystem through the intermediary platform, and has the third-party subsystem send the required payment information to the intermediary platform.

At block S160, the intermediary platform establishes communication with the user through text messaging or voice prompt, makes a deduction from the binding account upon receiving a feedback indicating that the user has confirmed the payment, and returns a processing result of the deduction to the third-party subsystem and the user. The communication from the intermediary platform to user using the communication client may be based on automated text messaging or TTS-based voice prompting.

The intermediary platform may establish communication with the user through voice prompt according to an exemplary procedure described as follows.

(A1) Categorize in advance voice information into dynamic voices and static voices, and determine a play order of the dynamic voices and the static voices.

(A2) Record and store in advance all static voices.

(A3) Record and store in advance the voice corresponding to each dynamic parameter in each dynamic voice to establish a dynamic parameter voice profile in a storage unit.

(A4) When the user needs to confirm the payment, determine the dynamic parameters of the voice message for the present payment confirmation including the amount of the payment.

(A5) Find the voice corresponding to each of the voice parameters of the voice message for the present payment confirmation from the dynamic parameter voice profile.

(A6) Create the voice message for present payment confirmation according to the predefined play order. The created voice message is sent to the communication client to be heard by the user.

Alternatively or additionally, the intermediary platform may establish communication with the user through text messaging according to an exemplary procedure described as follows.

(B1) Categorize in advance the text information into dynamic text portions and static text portions, and determine a combination order of the dynamic text portions and the static text portions.

(B2) When the user needs to confirm the payment, determine the parameter of each dynamic text portion of the text message for the present payment confirmation including the amount of the payment.

(B3) Create the text message for the present payment confirmation according to the predefined combination order and send the text information. The created text message is sent to the communication client to be viewed by the user.

The intermediary platform conducts a deduction from the binding account, and returns a processing result of the deduction to the third-party subsystem and the user according to an exemplary procedure described as follows.

(C1) If the intermediary platform receives a feedback requesting for making a payment by the user, the process continues to C2 below. Otherwise, the payment process is ended, and a processing result is sent to the third-party subsystem, or separately to the third-party subsystem and the user.

(C2) If the intermediary platform finds that the account has a sufficient balance, or the user has opened a payment card account which has a sufficient balance, the intermediary platform makes a deduction, and sends a processing result either to the third-party subsystem, or separately to the third-party subsystem and the user. The process ends hereafter.

An exemplary payment card account is AliPay CardPass which is a new type of online payment service jointly provided by AliPay and participating banks. After a cardholder binds an AliPay account with a bank savings account or a bank card account at a bank counter, a user may log into the AliPay account to complete an online payment transaction of the cardholder on AliPay directly using the bank savings account or the bank card account. The user thus enjoys the secure and convenient online payment service without having to open an online banking account.

(C3) If the intermediary platform finds that the payment card account does not have a sufficient balance, and the user has not opened a payment card account which has a sufficient balance, the intermediary platform instructs the user to recharge the account.

(C4) After the user has recharged the account, the payment process may continue with a voice callback method previously agreed-upon. The intermediary platform then checks again whether the account has a sufficient balance or the user has opened a payment card account. If the balance is sufficient or a payment card has been opened, the process proceeds to the above C2. Otherwise, the process proceeds to the above C3.

At block S170, the intermediary platform periodically conducts account checking and account settlement with the third-party subsystem and the card issuer's subsystem.

The user may configure a maximum limit for a deduction in advance (e.g., at the time of applying for the account). The intermediary platform makes a deduction if the user passes identity verification, and the payment satisfies maximum limit requirement. This type of configuration improves security as well as reduces the risks of making a payment. If a payment amount is greater than the maximum limit, stricter identity verification may be used to improve the security of the payment. Various identity verification methods may be used. For example, a password may be required to be entered, and compared with a pre-stored password. Identity verification is deemed successful if the password matches. Alternatively, the user inputs the last four digits of his/her identification card to be compared with the pre-stored identity verification information. Identity verification is successful upon a successful match. As identity verification technology is commonly known, its details will not be described herein.

The disclosed method may further have the intermediary platform establish a connection with the Internet, and conduct any operation requested by the user who accesses the intermediary platform through the Internet. Examples of such operations include setting up account information of the user, setting up user identity information, inquiring payment information and the account information, and binding the mobile telephone number with the account information.

The method and system disclosed herein may be used by both uses having an existing payment account (e.g., an AliPay user) or uses who don't have an existing payment account. This is illustrated using AliPay as an exemplary payment account. An existing AliPay user can conveniently make a payment using a mobile telephone number simply by establishing a binding relationship between the mobile telephone number and the existing AliPay account in advance. An existing non-AliPay user may create an account on AliPay simply by making a call from the mobile telephone number. The account name can be the mobile telephone number. The user may use an available AliPay account recharging method (e.g., recharging using a telephone) to charge or recharge the account to conveniently make a payment. Moreover, the disclosed method employs callback techniques to improve the security of a transaction. No additional hardware device is required for the user and the third party, thus incurring no additional cost.

The method is further described below using telephone AliPay as an exemplary implementation.

A toll-free telephone number is first opened in advance.

A wireless communication subsystem is added to the server system of Alipay.com to communicate with a telephone client through a connection established with a switching device of a carrier. Moreover, functionalities such as recharging air time for a mobile telephone, making a public service payment, recharging an AliPay account, making an order to a merchant, inquiring an account and a transaction, and configuring a system have been developed on Alipay.com. System configuration may allow features such as setting up the identity verification information, binding an account and a mobile telephone number, and closing or opening AliPay service.

After a user calls the toll-free telephone number using a telephone, AliPay determines whether the calling telephone number is a mobile telephone number. If negative, a registered mobile telephone number may be entered by the user and verified using a number verification process. If affirmative or otherwise a mobile telephone number entered by the user has been verified, the process continues to next step.

The system searches for an AliPay account that is bound with the mobile telephone number. If no such account is found, an account using the mobile telephone number as the account name is created.

Using voice prompt, AliPay instructs the user to select an operation to be conducted. For example, select “1” for recharging air time for a mobile telephone, select “2” for making a public service payment, and select “3” for making an order from a merchant, etc.

The processing is completed according to the operation selected by the user. For example, if “1” is selected, the communication client of the user establishes communication with a telecom carrier subsystem through the intermediary platform; the communication client of the user verifies with the telecom carrier subsystem the mobile telephone number that needs air time recharging and the recharge amount; the telecom carrier subsystem sends payment information including verification information of the telecom carrier subsystem and the recharge amount to the intermediary platform; and the telecom carrier subsystem determines whether to recharge based on a returned deduction processing result, and notifies the user of a recharging result.

If “2” is selected, the communication client of the user sends public service payment information including an order number that needs to be paid to the intermediary platform; the intermediary platform sends the public service payment information including the order number that needs to be paid to a related third-party subsystem; the third-party subsystem sends payment information including verification information of the third-party subsystem and fee information to the intermediary platform; and the third-party subsystem modifies the payment status of public service in a database of its own end based on a returned deduction processing result.

### Application Examples

1. Recharging Air Time for a Mobile Telephone

### (1) Recharging a Mobile Telephone for a Present User

(S11) The user presses a key to confirm the mobile telephone number. If the area or the carrier of the mobile telephone number of the user does not have a provider providing direct recharge services, the system notifies the user that recharging is not supported at the time and instructs the user to press “*” key to return.

(S12) The user enters the recharge amount. If a recharge amount entered by the user is not one of the designated values (e.g., 50 or 100), the system notifies of an input error, and requests for a new input.

(S13) If the recharge amount entered by the user results in a total recharge amount accumulated on the same day that exceeds a payment limit (e.g., two thousand dollars) for the account, the system indicates that the recharge amount has exceeded the payment limit, and requests a new input.

(S14) If the user has set up a user-defined limit, and the present recharge amount is greater than or equal to the user-defined limit, the system gives a prompt requesting the user to enter identity verification information, and conducts verification after the user confirms recharge information.

(S15) If the user's account does not have a sufficient balance, but is bound with a payment card account (such as ApliPay CardPass), the following procedure may take place depending on various scenarios:

a) If the default binding payment card account has been activated, the system initiates a deduction request to the default payment card account. If the deduction is successful, the respective fund within the account is frozen, and a recharge request is initiated. At the same time, the system notifies the user that the recharge request has been submitted, and asks the user to wait for a recharge result. If the deduction is unsuccessful, the system notifies the user of the failure and the reason (e.g., but in sufficient balance), and prompts for proper action (e.g., recharging the card account). If a status of deduction is not timely returned, the system notifies the user accordingly, or notifies that the balance is insufficient, and that the account needs to be recharged. Successfully deducted amount is deposited as a recharge amount into the AliPay account visited by the user.

b) If the default binding payment card account has not been activated, the system activates the default payment card account, and initiates a deduction request to the default payment card account. The procedures after a status of deduction is returned are the same as above.

c) If the default binding payment card account is non-activated and is a postal payment card account, the system does not activate the card, and notifies the user that the balance is insufficient, and needs to be recharged.

(S16) If the user's account does not have a sufficient balance, and has been bound with multiple non-activated payment card accounts, the system notifies the user that balance is insufficient and needs to be recharged, or instructs the user to enter into a payment card activation menu for activation.

(S17) If the user's account does not have a sufficient balance, and is not bound with any payment card account, the system notifies the user that balance is insufficient and needs to be recharged.

(S18) If a merchant returns a message to indicate that a transaction has been successfully established, the system presents to the user that the payment has been made and a recharge request has been submitted, and asks the user to watch for a recharge text reminder of the recharge operator, or directly call a customer service telephone number of the seller. At the same time, the system waits for a command from the merchant to advance the transaction and complete the payment while the fund within the user's account remains frozen. (The system automatically closes the transaction and unfreezes the fund in the user's account after seven days.)

(S19) If the merchant returns a message to indicate that the transaction has failed to be established, the system notifies the user that account recharging has failed, and the fund is unfrozen.

(S20) If the merchant has not returned a status to indicate whether the transaction has been established, the system presents to the user that a payment has been made and a recharge request has been submitted, and asks the user to watch for a recharge text reminder of the recharge operator, or directly call customer service telephone number of the seller. At the same time, the system waits for a command from the merchant to advance the transaction and complete the payment while the fund within the user's account remains frozen. (The system automatically closes the transaction and unfreezes the fund within the user's account after seven days.)

(S21) Accumulated recharge amount is limited by the payment limit of the accumulated sum (e.g., two thousand dollars) on the same day.

(2) Recharging a Mobile Telephone for Another User

(S41) If the user inputs a mobile telephone number to be recharged that is the same as the currently mobile telephone number used by the user to make the call, the system does not called back, but instructs the user to press a key for “recharge a mobile telephone for present user” to complete the recharging.

(S42) Each time when a mobile telephone number of another user is recharged, a single recharge amount cannot exceed a certain limit (e.g., two hundred dollars). Accumulated recharge amount is limited by a payment limit of an accumulated sum (e.g., two thousand dollars) on the same day.

(S43) After the user confirms the recharge information, the user needs to hang up, and receive a callback from the system to complete the payment.

(S44) If the system has failed to call back, or the user did not received a callback from the system in any event, the system sends a text message to remind the user of a failure in account recharging, and asks the user to restart recharging.

Other user behaviors are the same as those for “Recharging a mobile telephone for present user”.

2. Ordering a Product

The disclosed method and system support product order by a consumer or an agent in various businesses such as lottery, air ticket, TV shopping, catalog sales, and direct sales.

(1) For a User Who has Identity Information

(S61) AliPay and a merchant sign an agreement, and after that manually assign a merchant serial number to the merchant. Each merchant has a corresponding unique serial number, which may have four numerical digits for instance.

(S62) If a correct merchant serial number is entered, the system continues to instruct the user to input any quantity of a product to be ordered. If an incorrect merchant serial number has been entered, the system gives a prompt indicating that the designated merchant does not exist, and re-entry is needed.

(S63) The system submits the product title and the order quantity to the merchant to be parsed, and handles the following scenarios:

a) The merchant returns a result indicating successful parsing and the product details. The system reports the product details to the user and requests the user to press a key for confirmation.

b) The merchant returns a result indicating unsuccessful parsing. The system gives a prompt to the user to indicate that the product ordered by the user does not exist, and a re-entry is needed.

c) The merchant does not return a parsing result. The system presents to the user that the system is busy, and asks the user to try again later.

(S64) After the merchant returns a status of successfully parsing the product title, the system determines the transaction limit and the payment limit with the following different scenarios:

a) If the amount that needs to be paid for the presently ordered product exceeds the transaction limit (e.g., five thousands for a white list merchant, and two thousands for an ordinary merchant), the system indicates to the user that the amount exceeds the system's limit, and instructs the user to press * key to return.

b) If an accumulated amount after adding the amount for the presently ordered product exceeds the daily payment limit (e.g., five thousand dollars for a white list merchant, and two thousand dollars for an ordinary merchant), the system indicates to the user that user payment for the product exceeds the system's limit, and instructs the user to press * key to return.

(S65) If the system has failed to call back, or the user has failed to receive a call, the system sends a text message to the user indicating that the order is unsuccessful. If the user fails to confirm a payment after receiving a call, the system sends a voice prompt indicating that the order from the user is unsuccessful.

(S66) After the user receives a callback from the system, and confirms the payment by pressing a key, the process has the following exemplary scenarios:

a) The account has a sufficient balance. The system submits the order to the merchant. The system may optionally freeze the account's fund and may optionally transmit user information including a mobile telephone number and identity information to the merchant.

b) If the account does not have a sufficient balance, and is not bound with a payment card account, the system indicates that the order is unsuccessful and that the user balance is insufficient and needs to be recharged.

c) If the account does not have a sufficient balance, but has a default binding payment card account that has been activated, the system submits a deduction request to a bank and proceeds according to the following different scenarios:

if the deduction is successful, the system submits the order to the merchant. The system may optionally freeze the account's fund and may optionally transmit user information including a mobile telephone number and identity information to the merchant.

if the deduction fails, the system indicates that the order and the payment are unsuccessful, and instructs the user to try again later or to recharge the account.

if a deduction status is not returned timely, the system indicates that the order is unsuccessful, and instructs the user to pay attention to any change in the account balance.

d) If the account does not have a sufficient balance, and the default binding payment card account is a postal payment card, the system indicates that the order is unsuccessful and that the user's account has insufficient balance and needs to be recharged.

e) If the account does not have a sufficient balance, and the default binding payment card account has not been activated, the system activates the default payment card account, and initiates a deduction request and submits it to the bank associated with the default payment card account.

f) If the user's account does not have a sufficient balance, and has been bound with multiple inactivated payment card accounts, the system indicates that the order is unsuccessful and that the user does not have a sufficient balance and needs to recharge the account.

(S67) After the system submits the order to the merchant, the merchant returns the following statuses:

a) The merchant returns a status of successful order submission. The payment is processed using one of the following exemplary methods.

Freezing payment method: The system notifies the user that the order is successful, the payment is being processed, and to watch for a call from the merchant. The system waits for status information from the merchant about whether the delivery is successful to move forward with the transaction, and conducts an operation of “unfreezing and transferring the payment” or “unfreezing and closing the transaction”. Time for moving forward with the transaction by the merchant cannot be longer than a set maximum time period (e.g., seven days). If it has been longer than the maximum time period, the system automatically closes the transaction.

Non-freezing payment method: The system makes the payment to the merchant. Upon successful payment, the system notifies the user that the order and payment are successful, and asks the user to directly call a customer service telephone number of the merchant to confirm the delivery of the product.

b) The merchant returns a status of failed order submission. The payment is processed using one of the following exemplary methods.

Freezing payment method: The system notifies the user that the ordered product is temporarily out of stock, and indicates to the user that the order and the payment are unsuccessful, the transaction is closed, and the fund is unfrozen.

Non-freezing payment method: The system notifies the user that the ordered product is temporarily out of stock, and the present payment is unsuccessful.

c) The merchant fails to return a status of order submission timely. The payment is processed using one of the following exemplary methods.

Freezing payment method: The system notifies the user that order is being processed, and instructs the user to watch for any change of the account balance, and to directly call the customer service telephone number of the merchant. The system waits for status information from the merchant about whether the delivery is successful to move forward with the transaction, and conducts an operation of “unfreezing and transferring the payment” or “unfreezing and closing the transaction”. Time for moving forward with the transaction by the merchant cannot be longer than a preset maximum time period (e.g., seven days). If longer than maximum time period, the system automatically closes the transaction.

Non-freezing payment method: The system notifies the user that the ordered product is being processed, and the payment has not been made.

(2) For a User Who has No Identity Information

For a user having no identity information, or a user having a null (e.g., 0000) identification card information, the system requests the user to enter the complete identification card information before the process can enter into a procedure for making an order. The procedure for making an order is the same as the above-described payment procedure.

Compared with the existing technologies, the disclosed method and system have the following potential benefits.

First, the disclosed method and system combine a telephone-based payment method with a network-based payment method to utilize both wireless communication networks and the Internet. The method and system improves the utilization rate of resources and also the efficiency. Directly binding a payment account with a mobile telephone number makes it convenient to use. No additional device is required for a user or a third party, thus incurring no cost increase. In addition, the intermediary platform establishes communication with a user through text messaging or voice prompt, and makes a deduction of a binding account on the intermediary platform only after receiving a feedback indicating that the user has confirmed making the payment, thus improving the security of a transaction. Specifically, when the user makes the payment to the intermediary platform, the intermediary platform uses a verification procedure involving user callback using TTS technology. Through this procedure, the user is allowed to verify the information of purchased product(s), and avoids property loss in event of a mismatch between a calling mobile telephone number of the user and a stored verified mobile telephone number.

Second, the disclosed method and system conduct verification using a callback by the intermediary platform, and saves the user from having to make calls that may not only incur calling expenses but also lead to excessive long and ineffective waiting. Having a callback from the intermediary platform within a predefined time frame can reduce wasteful waiting time of the user which is very common with a conventional merchant call center. This not only reduces operating costs, but also improves the transaction experience of the user and increase the rate of successful transaction between the user and the merchant.

Third, besides allowing shopping using a telephone, the disclosed method and system expands business scope. For example, recharging of a mobile telephone account, and making a payment for a public service can be conducted using the telephone through the intermediary platform.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of making a payment using a communication client, the method comprising:
providing an intermediary platform which is adapted for establishing communication between a communication client and a third-party subsystem, wherein the intermediary platform has installed thereupon an account subsystem to establish communication with a payment card issuer and to accept an account recharging service;
upon receiving at the intermediary platform a call-in request from the communication client, determining whether the communication client has a mobile telephone number, and if negative, instructing the user to input a mobile telephone number;
determining whether the mobile telephone number has a payment account bound therewith, and if affirmative accepting a payment request from the communication client; and
making a deduction from the payment account and returning a processing result of the deduction to the third-party subsystem and the communication client.

2. The method as recited in claim 1, wherein the intermediary platform is adapted for communicating with the communication client wirelessly.

3. The method as recited in claim 1, wherein the intermediary platform is adapted for communicating with the communication client using automated text messaging or TTS-based voice prompting.

4. The method as recited in claim 1, wherein the third-party subsystem belongs to a third-party payee, and the payment request comprises at least information of the third-party subsystem.

5. The method as recited in claim 1, wherein the payment account bound with the mobile phone number is opened with the payment card issuer.

6. The method as recited in claim 1, wherein the intermediary platform is adapted for periodically conducting account checking and account settlement with the third-party subsystem and a subsystem of the card issuer.

7. The method as recited in claim 1, further comprising:
establishing a connection between the intermediary platform and the Internet, and performing an operation requested by a user who accesses the intermediary platform through the Internet, wherein the operation comprises one or more of actions including setting up account information of the user, setting up user identity information, inquiring payment information and the payment account information, and binding the mobile telephone number with the payment account.

8. The method as recited in claim 1, further comprising:
verifying the mobile telephone number.

9. The method as recited in claim 8, wherein verifying the mobile telephone number comprises:
sending a random verification code in form of a text message to the mobile telephone number;
receiving a user returned verification code; and
comparing the random verification code with the user returned verification code.

10. The method as recited in claim 1, wherein making a deduction from the payment account comprises:
pre-setting a maximum limit of the deduction; and
making the deduction by the intermediary platform if the deduction satisfies the maximum limit.

11. The method as recited in claim 1, wherein the intermediary platform is adapted for communicating with the communication client through a voice prompt using a process that comprises:
categorizing voice information into dynamic voices and static voices, and determining a play order of the dynamic voices and the static voices;
recording and storing the static voices;
recording and storing a voice corresponding to each of dynamic parameters of each dynamic voice to establish a dynamic parameter voice profile;
determining dynamic parameters of a current voice message;
finding the respective stored voice corresponding to each of the voice parameters from the dynamic parameter voice profile; and
creating the current voice message according to the predefined play order.

12. The method as recited in claim 1, wherein the intermediary platform is adapted for communicating with the communication client through text messaging using a process that comprises:
categorizing text information into dynamic text portions and static text portions, and determining a combination order of the dynamic text portions and the static text portions in advance;
determining parameters of each dynamic text portion of a current text message; and
forming the current text message to be sent to the communication client.

13. The method as recited in claim 1, wherein if the mobile telephone number does not have a payment account bound therewith, the method further comprises:
determining whether a payment account associated with the user of the communication client exists in the intermediary platform;
if affirmative, establishing a binding relationship between the payment account and the mobile telephone number; and
if negative, creating a payment account associated with the user and binding the payment account with the mobile telephone number.

14. The method as recited in claim 1, further comprising:
allowing the communication client to communicate with a telecom carrier subsystem through the intermediary platform, wherein the telecom carrier subsystem determines whether to recharge a user account based on a processing result of payment account deduction sent from the intermediary platform, and notifies the user of a recharging result.

15. The method as recited in claim 1, wherein the third-party subsystem is associated with a public-service, the method further comprising:
allowing the communication client to send public service payment information including an order number that needs to be paid to the third-party subsystem through the intermediary platform;
receiving at the intermediary platform from the third-party subsystem payment information including verification information of the third-party subsystem and fee information; and
returning from the intermediary platform to the third-party subsystem an account deduction processing result to allow the third-party subsystem to modify any payment status of the public service.

16. A system of making a payment, the system comprising an intermediary platform adapted for separately processing a request from a network client and a request from a communication client, the intermediary platform including:
a database;
a server center; and
a wireless communication subsystem,
wherein
the intermediary platform is adapted for allowing a user to make a payment to a third-party subsystem using either one or both of the network client and the communication client,
the wireless communication subsystem is adapted for establishing communication with the communication client through a wireless communication network,
the server center includes a network communication interface used for separately establishing communication with the network client and the third-party subsystem,
the database and the server center comprise an account subsystem including an account processing unit and an account storage unit, the account storage unit storing a binding relationship between a mobile telephone number and a payment account, and the account processing unit being adapted for creating the payment account and for creating and deleting the binding relationship between the payment account and the mobile telephone number,
the database further includes a payment information storage unit used for storing payment information, and for storing encoding rules that have been agreed upon between the third-party subsystem and the intermediary platform, and
the database further includes a third-party storage region used for storing a verification code of the third-party subsystem.
